(19) United States
(12) Patent Application Publication
(10) Pub. No.: US 2017/0326462 A1
(43) Pub. Date: Nov. 16, 2017

(54) SYSTEM, METHOD AND APPARATUS FOR PLAYER PRESENTATION IN VIRTUAL REALITY GAMING

(71) Applicant: Bally Gaming, Inc., Las Vegas, NV (US)

(72) Inventors: Martin LYONS, Henderson, NV (US); Rolland STEIL, Las Vegas, NV (US)

(21) Appl. No.: 15/590,178

(22) Filed: May 9, 2017

Related U.S. Application Data
(60) Provisional application No. 62/334,530, filed on May 11, 2016.

(51) Int. Cl. A63F 13/90; G06T 13/40; A63B 24/00; A63F 13/211; A63F 13/213; A63F 13/212; G07F 17/32; G02B 27/01

(52) U.S. Cl. CPC A63F 13/90; G07F 17/3293; G06T 13/40; G02B 27/0172; A63F 13/211; A63F 13/213; A63F 13/212; A63B 24/0006

(57) ABSTRACT

A gaming system includes an input interface, an output interface and processing circuitry. A data stream defining a VR environment is transmitted by the processing circuitry to a VR headset. The VR headset displays visual imagery depicting the VR environment seen from a first viewpoint. The processing circuitry receives an input indicative of a selection of a second viewpoint and directs the VR headset to display visual imagery depicting the VR environment seen from the second viewpoint.

### CROSS-REFERENCE TO RELATED APPLICATION

This application claims the benefit under 35 U.S.C. §119(e) of U.S. Provisional Patent Application Ser. No. 62/334,530 filed 11 May 2016.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, apparatus, and methods and, more particularly, to virtual reality gaming with multiple players.

### BACKGROUND OF THE INVENTION

Gaming providers (e.g., casinos, arcades, resorts, on-line services, etc.) seek to attract players by providing an array of gaming and gaining-related activities over communication networks and on-site, and may further offer non-gaming entertainment such as live music, theater, and sports events in hopes of attracting and retaining customers. In support of these goals, gaming providers may endeavor to provide cutting-edge entertainment technology whether it is directly related to gaining or not. Poker and other table games, multi-player video games, and live or computer-generated sports, in which a player may observe and wager on a variety of live and virtual events, are popular offerings with wide audiences, and virtual reality (VR) presentations of these and other entertainments are finding increasing acceptance. In addition, such offerings lend themselves to enhancements including advances in video presentations and expanded wagering opportunities.

VR equipment is becoming increasingly sophisticated and VR content providers are becoming more plentiful as VR experiences gain popularity. VR versions of multi-player games, conventional casino table games, and specialty tournaments attract a lot of attention and interest among the public. Additionally, VR leverages communication networks (e.g., the Internet) by facilitating remote participation in gaming and other entertainment vehicles that closely resembles the realism and urgency of “being there” in the flesh. There is a need to infuse VR gaming experiences with additional human-like characteristics, preferably drawn from observable attributes and behaviors of the actual players, to enhance the immersive nature of the VR environment.

The rise in remote and on-line gaming has been accompanied by the emergence of robots or “bots,” that is, computer programs that may masquerade as human players in a VR environment. Many human players find it unsatisfying, if not downright unfair, to compete with computer-controlled players. A single bot (or swarms of individual bots) can participate in multiple separate games simultaneously and, by using specialized algorithms and number-crunching processor power, can attain statistical advantages over human players (e.g., perform statistically near-perfect play). In addition, robot play may seem regimented and soulless to a human player—it may lack the peculiarities and spontaneity that breathe life into social game play. It would be advantageous for a gaming provider to utilize the features and capabilities of VR to provide a human-centric gaining experience for those players seeking such entertainment, and to identify (and possibly exclude) robot players in VR environments.

### SUMMARY OF THE INVENTION

According to one aspect of the present invention, a virtual reality (VR) gaming system includes an input interface and an output interface, and game-logic circuitry configured to connect first and second VR headsets to a client application that presents a multi-player wagering game played in a VR environment. The game-logic circuitry is further configured to initiate the wagering game in response to an input indicative of a wager, and receive real-time data representing facial expressions exhibited by a first player wearing the first VR headset. The facial expressions are detected by at least one detector of the first VR headset. The game-logic circuitry further directs the second VR headset to display play of the wagering game in the VR environment including a representation of the detected facial expressions of the first player.

According to another embodiment of the invention, a VR gaming system includes an input interface and an output interface, and processing circuitry configured to connect first and second VR headsets to a client application that executes a multi-player game in a VR environment. The processing circuitry is further configured to receive real-time data correlated to an alleged first human player wearing the first VR headset, wherein the real-time data is detected by at least one detector of the first VR headset. In response to determining that the real-time data indicates a human first player, the processing circuitry is further configured to direct the second VR headset to display play of the multi-player game in the VR environment including a representation of the first player wearing the first VR headset. In response to determining that the real-time data indicates a non-human first player, direct the second VR headset to alert the second player to a non-human participant in the multi-player game.

According to yet another embodiment of the invention, a method of operating a VR gaming system including an input interface, an output interface, and game-logic circuitry, comprises connecting, by the respective input and output interfaces, first and second VR headsets to a client application executed by the game-logic circuitry. The client application may present a wagering game in a VR environment. The method further includes initiating, via the game-logic circuitry, the wagering game in response to an input indicative of a wager, and receiving, by the input interface, real-time data representing facial expressions exhibited by an alleged first human player wearing the first VR headset during play of the wagering game. The facial expressions may be detected by at least one detector of the first VR headset. The method further includes analyzing, by the game-logic circuitry, the real-time data according to one or more human-identification methodologies. In response to the analysis determining that the real-time data indicates a human first player, the method includes directing, by the game-logic circuitry, the second VR headset to display the play of the wagering game in the VR environment including a representation of the detected facial expressions of the first player. Further, in response to the analysis determining that the real-time data indicates a non-human first player, the method includes directing, by the game-logic circuitry, the second VR headset to display an alert to the second player wearing the second VR headset.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a schematic depiction of a VR gaming system according to an embodiment of the invention.

FIG. 2 is an image of an exemplary VR headset.

FIG. 3 is an image of a user wearing a VR headset.

FIG. 4 is an image of an exemplary VR game screen depicting players in a poker game.

FIG. 5 is an image of exemplary selectable VR player avatars.

FIG. 6 is an image of an exemplary VR avatar displaying facial expressions and body movements based on real-time data from at least one detector in a VR headset.

FIG. 7 is a flowchart of an exemplary process utilized by an embodiment of the invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible to embodiment in many different forms, there is shown in the drawings and will herein be described in detail various embodiments of the invention with the understanding that the present disclosure is to be considered an exemplification of the principles of the invention and is not intended to limit the broad aspect of the invention to the illustrated embodiments. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games. For wagering games involving wagers of real money, the gaming system may be equipped with a value input device configured to detect a physical item associated with monetary value that establishes a credit balance. Subsequent wagers may be debited from the credit balance and applied to the wagering game, and awards from the wagering game may be credited to the credit balance. The gaming system may further receive a cashout input that initiates a payout from the credit balance. In an embodiment, the gaming system may include a bill validator, ticket reader, or a credit card reader for use accepting monetary value for a credit balance.

For purposes of the present detailed description, the terms “user interface,” “interface,” “visual field,” “audio field,” “pick field,” “virtual reality,” “VR,” “visual/audio presentation/component,” and the like describe aspects of an interaction between an electronic device and the player. This interaction includes perceivable output (e.g., audio, video, tactile, etc.) that is observed by the player, as well as electronically-generated input generated from real-world events (e.g., actuated buttons, physical position information, etc.) caused by the player or another real-world entity. In some embodiments, perceivable output may include a variety of information presented to a player (e.g., live sporting events, live casino gaming events, computer generated wagering games, etc.) using a number of perceivable stimuli, in a variety of formats using a variety of equipment (e.g., flat-screen computer monitor, curved monitor, VR headset, three-dimensional television, audio loudspeakers, audio headphones, directional audio, hypersonic sound projector, ranged acoustic device, three-dimensional audio, etc.). Such output may be presented in a combination of formats. In some embodiments, electronically generated input may include actuating or specifying specific regions or buttons of keyboards or touchscreens, detecting physical positions of pointing devices or sensors using relative or absolute measurements, and/or processing information gathered from one or more input devices to derive a resultant input signal containing information.

Virtual reality consoles, e.g., VR headsets, are known for providing an immersive interactive video experience to a user. These viewers typically are worn on the user's head and position a stereo-optical display for the user to view. The content may be presented in an auto-stereo, three-dimensional rendition. Virtual reality content can be created video content like interactive games and can be pre-recorded or live video streams captured by virtual reality capable cameras which can capture a 360° view of the environment. The content may be provided to the viewer as a data stream through a wireless network, e.g. ultra-high frequency band assigned for mobile cellular communications such as 2G, 3GPP and 4G, WiFi or the like, and, alternatively, through a wired connection. The viewers can include location and position sensors as well as gyroscopes and accelerometers such that the content is rendered based upon the user turning or dipping their head. Katz et al, US Pub. App. 2015/0193949 filed Jan. 5, 2015 and titled “Calibration of Multiple Rigid Bodies in a Virtual Reality System”, the disclosure of which is incorporated by reference, discloses such a viewer and supporting system. Perry, WO 2014/197230A1 filed May 23, 2014 and titled “Systems and Methods for Using Reduced Hops to generate Virtual-Reality Scene Within a Head Mounted System”, the disclosure of which is incorporated by reference, discloses a gaming VR headset using a handheld controller to provide user input. The head mounted display may include a forward looking digital camera to capture images of other parts of the users head and body.

A VR headset may be equipped with various other detectors for monitoring characteristics and attributes of the wearer. For example, detectors can monitor biometric characteristics like skin resistivity, blood pressure and heart rate, can scan irises for identification, and can detect and record eye-blinks and other eye movements over time.

VR headset may function as both an output display device and an input information gathering device. One example of this type of combination input/output device is the VR headset and functional processing unit sold as the Oculus Rift™ or Samsung Gear VR™, manufactured by Oculus VR of Menlo Park, Calif., USA. Other products offered by this company or others may be coupled to a gaming system, the headset, etc., and may include other input and output devices like pointers, actuation buttons, audio speakers, etc.

In an embodiment, a player may connect to the gaming system via a VR headset and be introduced to a VR environment defined by a data stream transmitted to the VR headset from the gaming system. The data stream may deliver pre-rendered, streaming visual and audio imagery directly to the VR headset. Alternatively, the data stream may comprise raw or partially rendered data that includes stored visual and/or audio imagery. The data stream may further include instructions for rendering a portion of the data into three-dimensional scenarios and may be configured to receive inputs from various sources such that the received inputs affect visual, audio, or other aspects of the VR environment. The data stream may be rendered and/or otherwise processed by local or remote processing circuitry and transmitted to the VR headset for display to the player. Alternatively, the data stream may be rendered by processing circuitry resident in the VR headset. The data stream may be delivered to the player via a direct transmission line, via an intranet communications network, via the Internet, or via various other data delivery means and methods. Processing circuitry resident in one or more components of the gaming system and/or the VR headset may execute instructions to generate one or more elements of the data stream and to alter the one or more elements in response to received inputs from various sources.

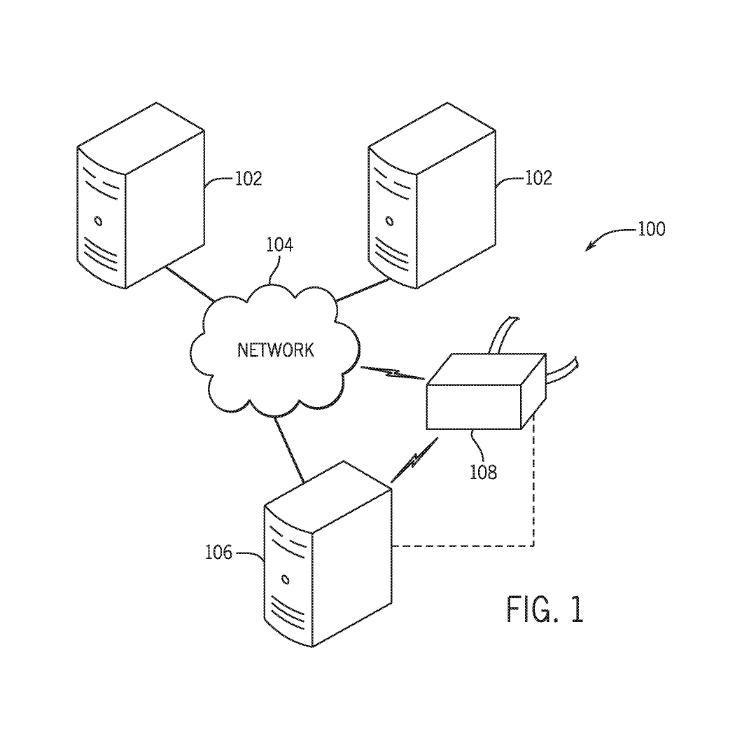

Referring now to FIG. 1, a gaming system 100 providing access to a VR environment is depicted. One or more game servers 102 are connected to a communications network 104 via input and output interfaces. The game servers 102 may be operated by different gaming providers and each may transmit one or more data streams defining different VR environments. For example, a game server 102 may provide a multi-player fantasy war game to subscribers—with players signing in to dedicated player accounts with verifiable identifiers. Similarly, a game server 102 may operate a multi-player casino game such as Hold'em Poker or roulette and enable players from the general public to connect and participate by paying a fee. In an embodiment, a VR game may be executed by a client application running on the game server 102 or running on a remote computing device and transmitted via the game server 102.

The game server 102 includes processing circuitry configured to administer stored instructions and/or to process a VR data stream generated internally or received from a remote source. The VR data stream is delivered, from the game server 102, to a user via various transmission modes, for example, from the game server 102 to a communication network 104 and directly to a VR headset 108 via wired or wireless transmission, or to a communication network 104 to a local computing device 106 for further processing before transmitting to the VR headset 108. Thus, the VR headset 108 may receive a pre-rendered VR data stream—effectively ready for display by the VR headset—or the VR data stream may be rendered by the local computing device 106 before delivery to the VR headset. Also, in an embodiment, an unrendered VR data stream may be processed by the VR headset via onboard circuitry.

In some embodiments, the game provided in the VR environment may be a wagering game that involves wagers of real money, as found with typical land-based or online casino games. These types of games are sometimes referred to as pay-to-play (P2P) gaming. In other embodiments, the game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). These types of games are sometimes referred to play-for-fun (P4F) gaming. When provided in a social or casual game format, the wagering game may closely resemble a traditional casino game, or it may take another form that more closely resembles other types of social/casual games.

In some embodiments, the games may not involve wagering at all, either real currency or virtual currency, but may instead be non-wagering games that are competitive, strategy-based, cooperative, or combinations thereof. Games may include role-playing games, board games, arcade games, educational games, and various other genres.

The communication network 104 may be an intranet provided by the gaming provider. The communication network 104 may be an open network such as the Internet, and may be a combination of an intranet and an open network. A user may connect to the VR environment from a gaming venue or from a remote location such as the user's home. A VR headset may be provided by a gaming provider or may be the personal property of the user. All that may be needed to connect and participate in a VR gaming session is access to the Internet, a VR headset, and whatever equipment is needed to connect the VR headset to the Internet.

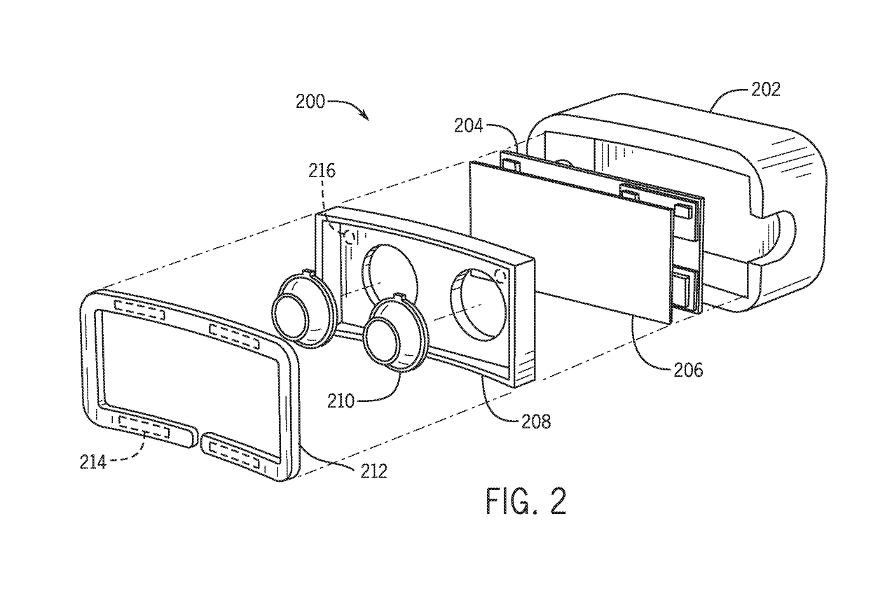

Referring now to FIG. 2, shown is an exemplary VR headset 200. The headset 200 includes a housing 202 that serves to protect the internal components and to limit the user's visual experience to the images provided by the headset 200. The VR headset 200 may further include processing circuitry 204 (on a circuit board) for receiving a VR data stream for processing data for a visual portion of the VR environment, for processing an audio portion of the VR environment, for receiving data from any VR headset detectors and/or input devices, and for transmitting data from the VR headset.

A display device 206 (e.g., screen) may be provided in the VR headset to receive and display video data that makes up the visual aspect of the VR environment. The display device 206 may be one or more LCD, LED, OLED, or other display device. Alternatively, the display device 206 in some embodiments may be a mobile phone retained by the headset 200 in the proper position with its video display facing the user's eyes.

In an embodiment, the VR headset 200 further includes an internal frame 208 for positioning lenses 210 between the user's eyes and the display device. The internal frame 208 may also provide support for one or more detectors, for example, a face-directed imager such as the face-directed cameras 216 that may capture real-time dynamic video of facial characteristics of the user. Other face-directed sensors and imagers may include light sensors that detect reflected light from an open eye, visible wavelength or near infrared imagers for retinal scanning, and various other sensors and detection devices.

A VR headset may include a facial gasket 212 to promote user comfort and also to ensure a good seal against light intrusion from outside of the VR headset. In an embodiment, a facial gasket 212 further includes one or more detectors 214 embedded within the gasket material or attached to the gasket surface. For example, a detector 214 may be a strain gage configured to detect and measure skin movement indicative of changing facial expressions. Alternatively or additionally, a detector 214 may be configured to measure skin resistivity. Various other detectors are envisioned to be included in a VR headset and to be within the scope of the invention. Data gathered by the detectors 214, the face-directed cameras 216, and other sensors and detectors that may be included in the VR headset 200 may be received by the processing circuitry 204 and may be transmitted to a game server 102 or to a local computing device 106 for primary or secondary processing. The level of processing performed by the VR headset components is variable and may depend on any of the type of headset, the communications network, wired or wireless connection, and the gaming provider hosting the particular VR environment.

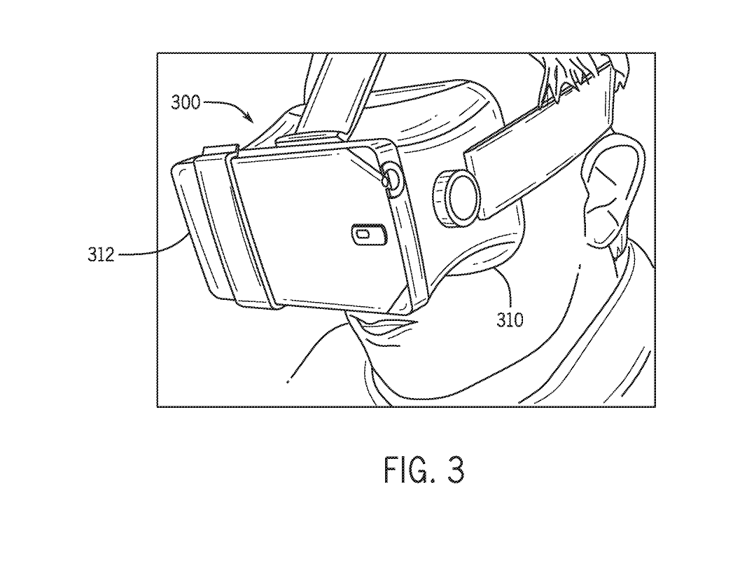

FIG. 3 depicts a VR user wearing a VR headset 300. In this embodiment, the VR headset 300 includes headgear 310 holding a mobile phone 312 in position in front of the user's eyes. The VR headset may include interior lenses (not shown) that facilitate stereoscopic viewing of the mobile phone screen. With the mobile phone 312 in place on the headgear 310, the user's vision is restricted to only the mobile phone screen with the headgear 310 fitting closely to the user's face and blocking any ambient light from penetrating inside the headgear 310. Excluding outside stimuli helps the VR headset to create the immersive experience for the user.

Once the user (wearing the VR headset) enters the VR environment, they see (and, in some embodiments, hear) the images (and sounds) that are provided by the VR system. For example, a user entering a VR boxing game may find themselves in an old-time boxing ring in a sold-out Madison Square Garden. Thousands of fans fill the seats and mill around in the aisles laughing, cheering, jeering as the boxers enter the ring. On the other hand, a VR golf game may present the open fairways and sunshine of Augusta National Golf Club with the onlookers sequestered and hushed at the perimeter of the field.

Whatever scene is presented to the user in the VR environment, the sensors and detectors in the VR headset may monitor various aspects of the user as they interact with the VR environment. Referring back to FIG. 2, a face-directed camera 216 may capture the user's eye blinks, eye and eyebrow movements, and retinal qualities, to name just a few of the characteristics that are observable within the headgear. Similarly, other detectors (e.g., 214) may measure skin temperature, resistivity, heart rate, and various biometric attributes—even skin wrinkling as facial expressions change.

Information from the sensors and detectors in the VR headset maybe included in the real-time data delivered to processors, controllers, and or logic circuitry of the gaming system. Some of the data may be processed and incorporated in a digital or analog representation of the user. For example, data associated with facial expression may be used to generate a real-time depiction of the user's facial expressions as they participate in the VR environment. Additional data from exterior detectors, for example a remote camera, may be included to produce a full—or nearly full—body representation of a user that moves and reacts in synch with the corresponding real-time behavior of the user.

The representation of the user generated from the real-time data may be included in the VR environment so that other users in the environment may see, hear, and/or interact with the user. Enhancing the representation with dynamic facial expressions, movements, and other information not only makes the representation seem more lifelike but also provides real and perceived cues that other players in the VR environment may interpret and react to. For example, returning to the boxing game example, if a player sees his opponent glance away momentarily, drop one of their hands, or readjust their stance, these observations be utilized by an opponent to anticipate a punch, direct a counterpunch, press an attack, or retreat.

In another example of a VR environment, a user participates as a player in a poker game. The user is represented in the poker game by a digital or analog representation in the form of an avatar that mimics the user's actual facial expressions, movements and other behaviors, and the other players are each represented by their own avatars. The players may observe each other's behaviors (as depicted by their respective avatars) as the cards are dealt and viewed, and as bets are placed, called and raised, and as additional cards are dealt to individuals or as community cards. How each player reacts to occurrences in the game play may be interpreted by other players and, in turn, may affect game play decisions of the other players. As in a real, face-to-face poker game, the players can search for “tells” that may indicate whether an opponent is bluffing or not. Likewise, players can project false and misleading behavior intended to confound their opponents. In this way, the invention may present VR games that more closely depict the various human elements that may be missing in conventional on-line games.

In some embodiments, real-time data from sensors and detectors in the VR headset can be evaluated to determine whether a user is a real human user or more likely to be a programmed entity or robot (“bot”). Processors, controllers, and logic circuitry may analyze the real-time data by comparing the data to known and/or postulated characteristics displayed by real humans. There are many known techniques for analyzing observed characteristics according to one or more human-identification methodologies. For example, seemingly random eye movements may be analyzed for similarities to computer-generated, simulated randomness versus actual movement patterns observed in prototypical human subjects. A similar analysis may be performed on data correlated to eye blinks. Of course, biometric data like heart rate, blood pressure, and skin temperature may be classified as being in the normal human range or not. Further, changes in biometrics may be compared to predicted fluctuations resulting from game play situations. By monitoring, analyzing, and assessing the real-time data, a gaming provider may alert other players to the presence of a suspected non-human player, or may exclude suspected non-human players from designated “human only” VR environments. In an embodiment, biometric data from the at least one detector is compared to stored player profile data for the purpose of identifying the user.

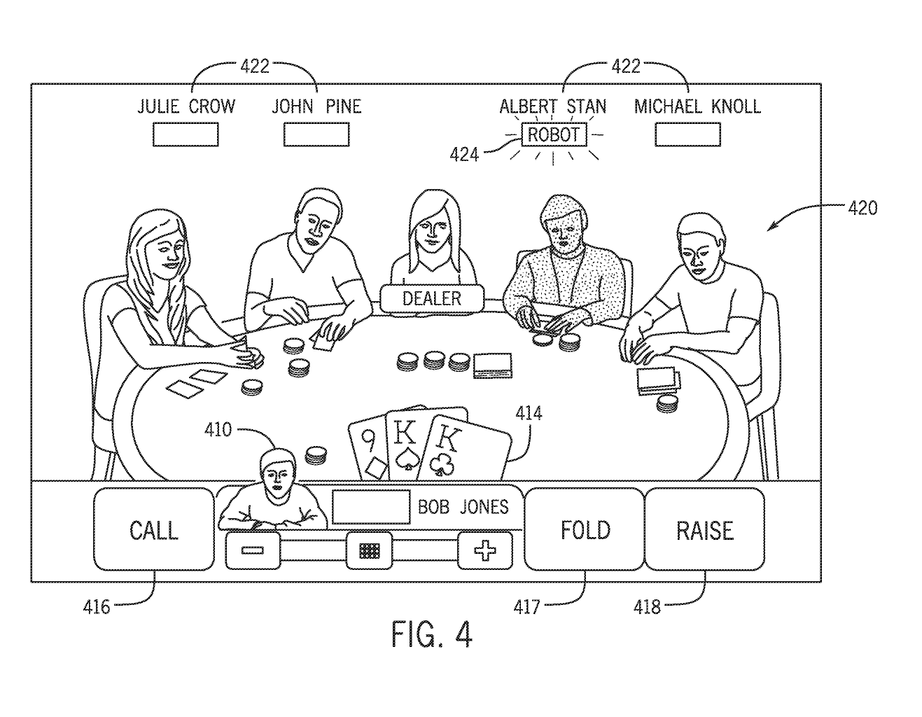

FIG. 4 depicts a view of an exemplary VR environment in which the user is a player in a multi-player poker game. The user 410 (i.e., “Bob Jones”) sees a “first person” view of a poker table 412 with digital and/or analog representations of the game's other participants 420 arrayed around the table. The user's dealt hand 414 is shown along with input indicators (e.g., a virtual button panel) for receiving user inputs during game play. For example, the button panel shown include a CALL button 416, a FOLD button 417, a RAISE button 418, and other buttons for adjusting wager amounts. Various means and methods for receiving and identifying user inputs are considered to be within the scope and spirit of the invention, as discussed previously. User input indicators may be context-sensitive and change in response to the progress of game play. For example, an ANTE button may be shown at the start of a hand, then be replaced by the FOLD button after an initial deal. Analogous context-sensitive input features can be easily envisioned for different games and varying gaming conditions and are considered to be within the scope and spirit of the invention.

The representations of all the players, including the user as seen by the other participants, may be dynamic—reflecting the changing player characteristics and behaviors captured by the sensors and detectors of respective VR headsets (and other, external sensors) and encoded into the real-time data received by the gaming system. Thus, the facial expressions, head and/or body movements, eye movements, etc. discussed above may be displayed in real-time or near-real-time by the respective representations. Metric data (e.g., blood pressure, skin resistivity, etc.) may be displayed in tabular, graphic, or other forms and may assist the players in assessing their opponent's play.

Referring again to FIG. 4, the participating players 420 are identified by player-selected nicknames 422, and may also be accompanied by additional player-specific information. In an embodiment, player-specific information may include respective chip counts or available credits. As previously discussed, the real-time data correlated to a particular player may be analyzed and determined to indicate a non-human player. In FIG. 4, the player nicknamed “Albert Stan” is identified as a potential robot and an alert 424 is displayed below the player nickname. Additionally (or alternatively), the representation of “Albert Stan” is shaded or greyed out to indicate its suspected robot status. Various alert protocols and display indicia may be implemented by the gaming system to alert players of a suspected robot participant. In this way, the real-time data collected from the VR headset sensors and detectors may serve to identify potential unauthorized players.

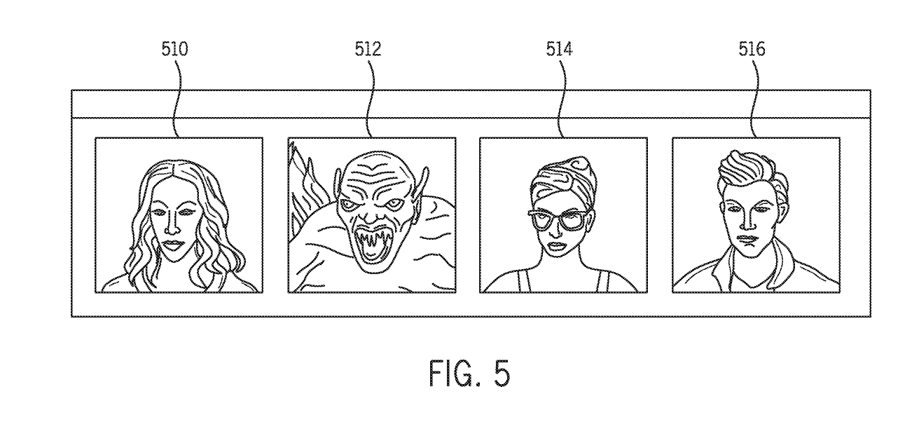

In an embodiment shown in FIG. 5, a user may select an avatar 510-516 to serve as their representation, and the real-time data correlated to the user may be applied to the avatar, including but not limited to facial expressions, body movements, and other behaviors and characteristics. For example, a player's facial expressions may be mapped to the facial features of an avatar. The avatar may be realistic (e.g., avatars 510, 514, and 516) or fanciful (e.g., avatar 512). In another embodiment, the game system may assign an avatar to a player, or even accept a player-supplied avatar representation. In an embodiment, a photograph of the player may be adapted and applied to an avatar. Once selected/assigned, the avatar will be displayed as a participant in the VR environment. In an embodiment, a user may access the VR environment via a player account that includes a pre-selected avatar that is displayed to represent the user in VR environment.

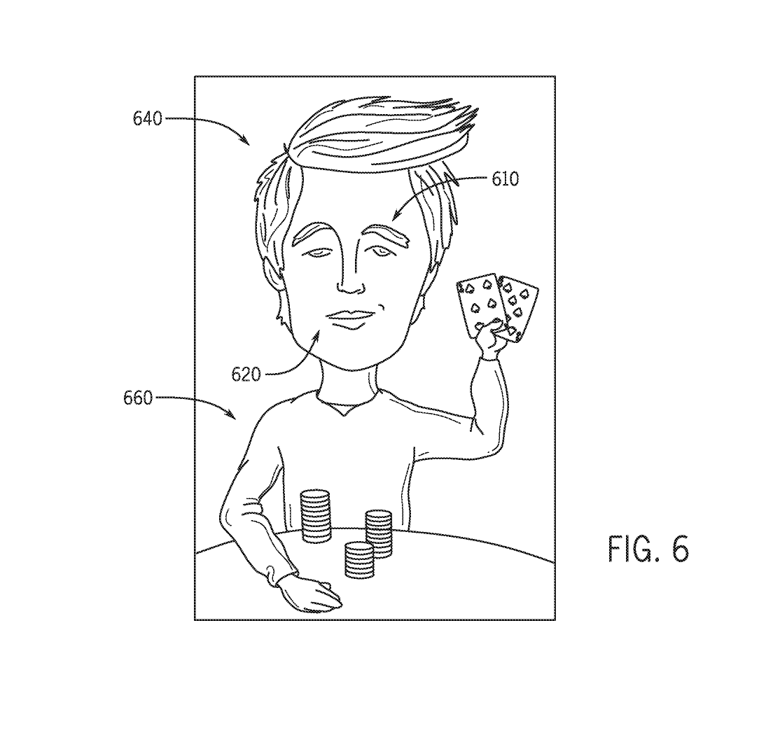

FIG. 6 is an exemplary depiction of an avatar representing a user participating in a VR card game. As can be seen in the view, the avatar presents a facial expression, posture, and body language that may be interpreted by other card game participants. For example, the avatar's eyes and eyebrows 610, mouth 620, head position 640, shoulders 660, etc. may provide different and sometimes conflicting cues. In the dynamic VR environment, the avatar's body movements, changing expressions, and even involuntary tics and reactions may be reproduced in real-time by the game system and so provide even more detailed information. As such, with the increased accuracy and scope provided by detectors in the user's VR headset and, possibly, other detectors and sensors viewing the user, the overall behavior of the avatar provides numerous indicators (both real and perceived) from which an opposing player may draw inferences as to the user's state of mind. These indicators and interpretations add a dimension of strategy, excitement, and unpredictability to VR gaming that may be attractive to many players.

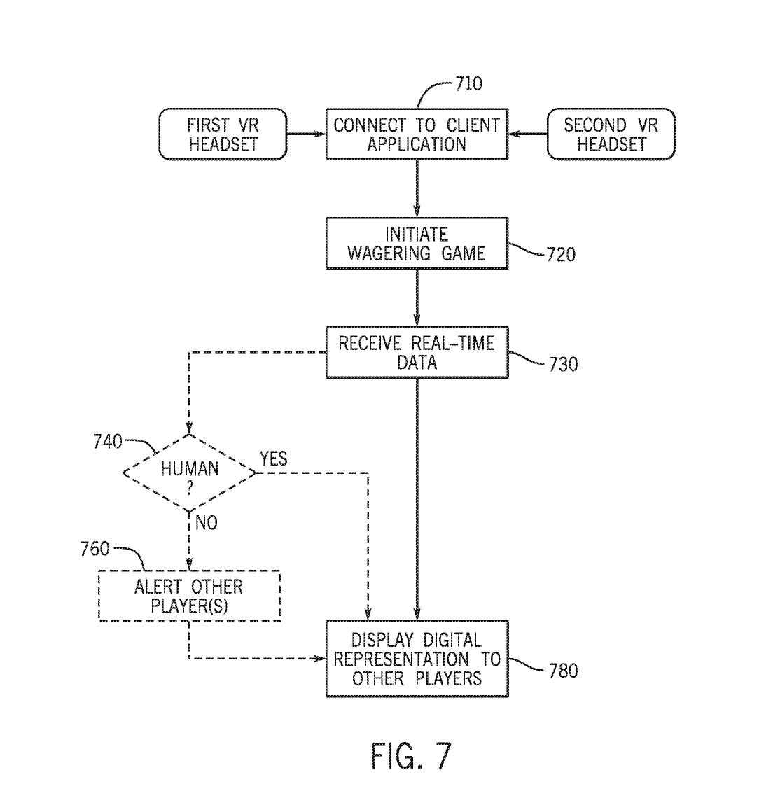

FIG. 7 is a flowchart for data processing performed by an embodiment of the invention. In step 710, a gaming system connects a first VR headset and a second VR headset to a client application that executes a wagering game played in a VR environment. In step 720, the wagering game is initiated between at least first and second players operating the respective first and second VR headsets. In step 730, the gaming system receives real-time data correlated to the first player, and may also receive real-time data correlated to the second player. The real-time data from the VR headsets will be processed by the gaming system to create a digital or analog representation of the facial expressions exhibited by the first player and, optionally, the second player.

In the embodiment depicted in FIG. 7, the real-time data is optionally analyzed, in step 740 by the gaming system to determine if the data is indicative of a human player or a robot. As described above, various methods may be employed in this determination. If the system determines that the data indicates a human player, the processing proceeds to display the wagering game in the VR environment in step 780 and includes a representation of the first player (e.g., an avatar that exhibits the facial expressions of the first player) to the second player and any other player participating in the wagering game. If the system determines that the real-time data is incompatible with a human player, in step 760 the gaming system may alert the second player (and any other players) that the first player may be a robot before displaying the wagering game. In an embodiment, the gaming system may exclude a presumptive robot from game play altogether.

The foregoing description, for purposes of explanation, uses specific nomenclature and formula to provide a thorough understanding of the disclosed embodiments. It should be apparent to those of skill in the art that the specific details are not required in order to practice the disclosed embodiments. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A virtual reality (VR) gaming system comprising:
an input interface;
an output interface; and
game-logic circuitry configured to:
connect, via the respective input and output interfaces, first and second VR headsets to a client application that presents a multi-player wagering game played in a VR environment;
initiate the wagering game in response to an input indicative of a wager;
receive, via the input interface, real-time data representing facial expressions exhibited by a first player wearing the first VR headset during play of the wagering game, the facial expressions being detected by at least one detector of the first VR headset; and
direct the second VR headset to display the play of the wagering game in the VR environment including a representation of the detected facial expressions of the first player.

2. The VR gaming system of claim 1, wherein the detector captures the real-time data while the first player places at least one bet in the wagering game and the real-time data represents the first player's facial expressions before, during, and after placing a bet.

3. The VR gaming system of claim 1, wherein the detector captures the real-time data while the first player views a dealt card in the wagering game and the real-time data represents the first player's facial expressions before, during, and after viewing the dealt card.

4. The VR gaming system of claim 2, wherein the game-logic circuitry is configured to receive, via the input interface, data representing body movements of the first player during play of the wagering game, the body movements being detected by one or more external cameras, the representation including the detected body movements of the first player.

5. The VR gaming system of claim 4, wherein the game-logic circuitry is configured to receive data representing eye movements detected by the detector, and to evaluate the detected eye movements with respect to prototypical eye movements of human beings.

6. The VR gaming system of claim 1, wherein the detector includes a face-directed imager and the data representing the facial expressions is provided by the face-directed imager.

7. The VR gaming system of claim 1, wherein the representation of the facial expressions is mapped to a computer-generated avatar representing the first player in the wagering game.

8. The VR gaming system of claim 1, wherein the game-logic circuitry is configured to receive, via the input interface, biometric information detected by the detector and to identify the first player by comparing the received biometric information with stored player profile data.

9. A VR gaming system comprising:
an input interface;
an output interface; and
processing circuitry configured to:
connect, via the respective input and output interfaces, first and second VR headsets to a client application that executes a multi-player game in a VR environment;
receive, via the input interface, real-time data correlated to an alleged first human player wearing the first VR headset, the real-time data being detected by at least one detector of the first VR headset;
in response to determining that the real-time data indicates a human first player, direct the second VR headset to display play of the multi-player game in the VR environment including a representation of the first player wearing the first VR headset; and
in response to determining that the real-time data indicates a non-human first player, direct the second VR headset to alert the second player to a non-human participant in the multi-player game.

10. The VR gaming system of claim 9, wherein the processing circuitry is configured to analyze the real-time data according to one or more human-identification methodologies and wherein the results of the analysis indicate whether the first player is human or non-human.

11. The VR gaming system of claim 10, wherein the one or more human-identification methodologies includes evaluation of the real-time data with respect to prototypical behavioral characteristics of humans.

12. The VR gaming system of claim 9, wherein the real-time data includes biometric data correlated to the alleged first human player.

13. The VR gaming system of claim 9, wherein the detector includes a face-directed imager gathering real-time data representing facial expressions exhibited by the alleged first player and wherein the representation includes the facial expressions.

14. The VR gaming system of claim 13, wherein the facial expressions include eye movement and wherein the one or more human-identification methodologies includes evaluation of the detected eye movement with respect to prototypical human eye movements.

15. The VR gaming system of claim 13, wherein the facial characteristics include eye blink characteristics and wherein the one or more human-identification methodologies includes evaluation of the detected eye blink characteristics with respect to prototypical human eye blink behaviors.

16. The VR gaming system of claim 13, wherein the facial expressions are mapped to a computer-generated avatar representing the first player in the multi-player game.

17. A method of operating a VR gaming system including an input interface, an output interface, and game-logic circuitry, the method comprising:
connecting, via the respective input and output interfaces, first and second VR headsets to a client application executed by the game-logic circuitry, the client application presenting a wagering game in a VR environment;
initiating, via the game-logic circuitry, the wagering game in response to an input indicative of a wager;
receiving, via the input interface, real-time data representing facial expressions exhibited by an alleged first human player wearing the first VR headset during play of the wagering game, the facial expressions being detected by at least one detector of the first VR headset;
analyzing, via the game-logic circuitry, the real-time data according to one or more human-identification methodologies;
in response to the analysis determining that the real-time data indicates a human first player, directing, by the game-logic circuitry, the second VR headset to display the play of the wagering game in the VR environment including a representation of the detected facial expressions of the first player; and
in response to the analysis determining that the real-time data indicates a non-human first player, directing, by the game-logic circuitry, the second VR headset to display an alert to a second player wearing the second VR headset.

18. The method of claim 17, wherein the one or more human-identification methodologies includes evaluation of the real-time data with respect to prototypical behavioral characteristics of humans.

19. The method of claim 17, wherein the detector includes a face-directed imager and the data representing the facial expressions is provided by the face-directed imager.

20. The method of claim 17, wherein the representation of the facial expressions is mapped to a face of a computer-generated avatar representing the first player.
